(19) United States
(12) Patent Application Publication
(10) Pub. No.: US 2009/0142199 A1
(43) Pub. Date: Jun. 4, 2009

(54) Quick lift zero flutter oil service pump valve

(75) Inventor: Ivan Blanco, Duncan, OK (US)

Correspondence Address: JOHN W. WUSTENBERG, P.O. BOX 1431, DUNCAN, OK, 73536, US

(73) Assignee: HALLIBURTON ENERGY SERVICES, INC., Houston, TX (US)

(21) Appl. No.: 11/947,661

(22) Filed: Nov. 29, 2007

(51) Int. Cl. F04B 53/10; E21B 34/16; F16K 15/06; F04B 39/10

(52) U.S. Cl. 417/53; 137/542; 166/373; 417/559

(57) ABSTRACT

A suction valve for a positive displacement pump. Two springs are used to actuate a valve plug. A first spring has an uncompressed length greater than a distance between a spring retainer and the valve plug, providing a preload force closing the valve. A second spring has an uncompressed length less than the distance between the retainer and the plug, providing closing force to the plug only after a preselected valve lift. The first spring is relatively light and permits rapid opening of the valve to avoid cavitation. The second spring increases the effective spring constant when the valve is open to prevent flutter and to assist in closing of the valve upon commencement of a discharge pump stroke.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

Embodiments described herein relate to positive displacement pumps, and more specifically to devices and methods to improve the efficiency, durability, performance, and operating characteristics of reciprocating positive displacement pumps (of the sort that might be used in pumping wellbore servicing fluids) by using a multiple, e.g. two, spring system for operating suction valve(s) of the pump.

### BACKGROUND OF THE INVENTION

Positive displacement pumps, and specifically reciprocating pumps, are used in all phases of oilfield operation to pump water, cement, fracturing fluids, and other stimulation or servicing fluids. Pumps in oil field operations often endure harsh conditions, especially when pumping abrasive fluids (such as fracturing fluids). Thus, there is an ongoing need for improved pumps and methods of operation for pumps, allowing for more effective oil field pumping operations in the face of such harsh operating conditions.

### SUMMARY OF THE INVENTION

Disclosed herein is a suction valve for a positive displacement pump. At least two springs are used as an actuator for a valve plug. A first spring has an uncompressed length selected so that it is compressed when the valve is closed, thereby providing a preload force urging the valve toward a closed position when the valve is closed and increasing force as the valve opens. A second spring has an uncompressed length selected so that the second spring is not compressed until after a preselected valve plug lift. The first spring is relatively light, as compared to the prior art, and permits rapid opening of the valve to avoid cavitation. The second spring increases the effective spring constant when the valve is open to prevent flutter and to assist in closing of the valve upon commencement of a discharge pump stroke.

### BRIEF DESCRIPTION OF THE DRAWINGS

FIG. 1 is a cross-sectional view of a cylinder of a positive displacement pump which may incorporate a multiple spring valve system as disclosed herein.

FIG. 2 is a graph illustrating operating parameters of positive displacement pumps according to the prior art and according to the disclosed embodiments.

FIG. 3 is a cross-sectional view of a valve incorporating a multiple spring system as disclosed herein.

### DETAILED DESCRIPTION OF THE PREFERRED EMBODIMENTS

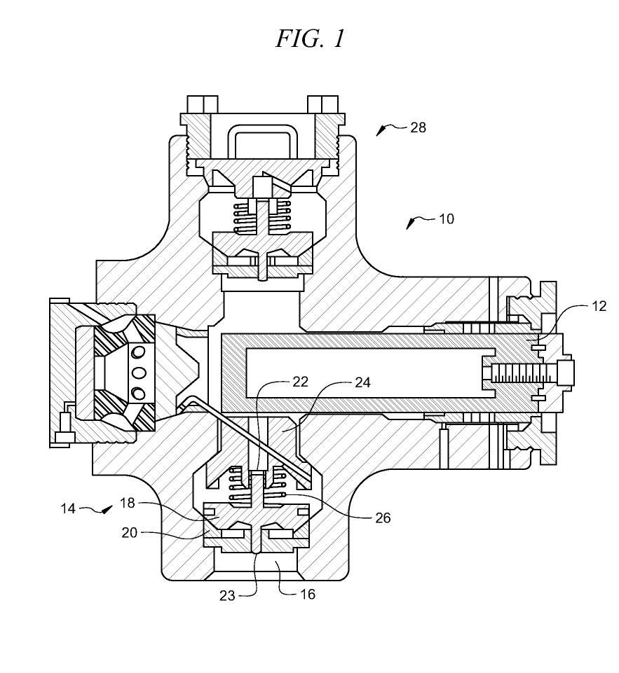

FIG. 1 is an illustration of a cylinder 10 of a positive displacement pump which may incorporate a multiple spring valve system as disclosed herein. The cylinder includes a piston 12 which is moved in and out of the cylinder 10 to alternately produce discharge pressure and suction pressure in the cylinder 10. The piston 12 is driven by a prime mover such as a motor as well known in the art. A suction valve 14 is provided between the cylinder 10 and a suction inlet 16. The inlet 16 is connected to a source of fluid such as a well treating fluid, e.g. fracturing fluid. The suction valve 14 includes a moving valve plug 18 and a valve seat 20. The valve plug 18 includes a stem 22 which may move within a guideway in a spring retainer 24. In this embodiment, the valve plug 18 also has a second valve stem 23 which may move within a guideway below the valve seat 20. A valve actuator, in this case a spring 26, is provided around stem 22 and between the spring retainer 24 and the valve plug 18 and constantly applies force to the valve plug 18 urging it into contact with the valve seat 20. On the suction stroke of piston 12, low pressure, i.e. suction, is created within cylinder 10 and the pressure differential between the cylinder pressure and the pressure head at the suction inlet 16 overcomes the force of spring 26 and moves, or lifts, the valve plug 18 away from the seat 20 allowing treating fluid to flow into the cylinder 10. At the end of the suction stroke, the spring 26 continues to urge the valve plug 18 back into contact with the seat 20, i.e. into the closed position.

On the discharge stroke of piston 12, the piston 12 is moved into cylinder 10 creating high pressure in the fluid within the cylinder 10. If the spring 26 has not completely closed the suction valve 14, the increasing discharge pressure closes it. A discharge valve 28 is provided between the cylinder 10 and a discharge outlet. The discharge valve 28 may be essentially identical to suction valve 14. The high discharge pressure in cylinder 10 forces the discharge valve 28 open to allow the fluid in cylinder 10 to be pumped out a discharge outlet and typically into a well for a well servicing treatment such as a fracturing operation. Further details regarding such fracturing pumps are disclosed in U.S. Pat. No. 5,226,445, which is hereby incorporated by reference for all purposes

Several problems may occur in operation of a well servicing pump such as illustrated in FIG. 1. One problem is cavitation. Cavitation is the generation of a bubble of vacuum and/or vaporized liquid in the liquid being pumped. Cavitation can occur during the suction stroke of a piston if the suction valve does not open fast enough to allow free flow of service fluid into the pump cylinder. Opening speed of a suction valve is affected by the mass of the valve plug, the strength of the valve spring, the pressure head at the suction fluid inlet, and other factors. Increasing valve plug size, e.g. diameter, is desirable because it can assist opening by allowing suction pressure to operate on a larger area, however this generally increases mass of the valve plug which slows valve opening. Use of a weaker valve spring can assist opening of a suction valve, however if a spring is too weak the valve plug may impact a spring retainer and may flutter, both of which can cause damage to the valve and/or reduce the efficiency of the pump. A weak spring may also not provide enough force to quickly close the suction valve for the discharge stroke which may reduce pump efficiency. If cavitation occurs on the suction stroke, then during the discharge stroke the bubble collapses creating a pressure spike, sometimes called water hammer effect, which can damage valves and other parts of pumps and flow lines.

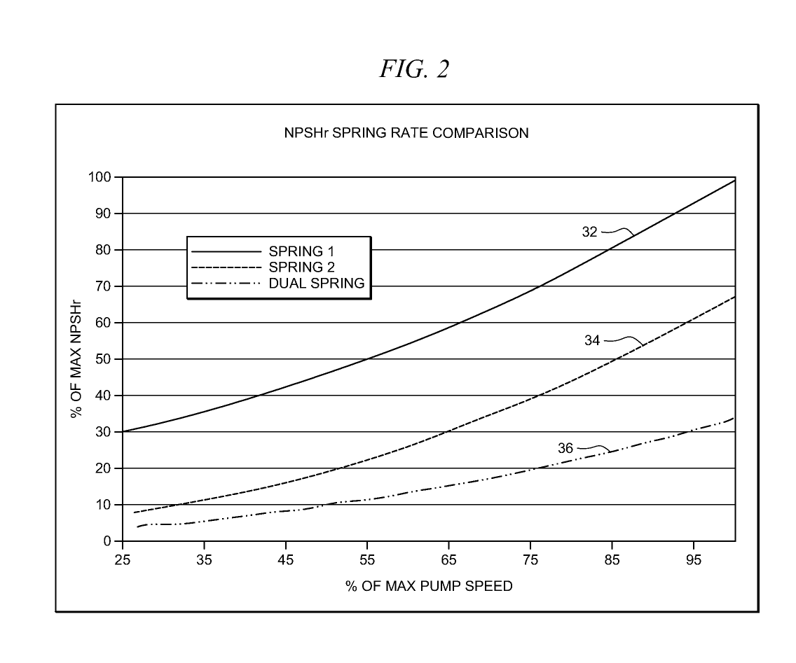

FIG. 2 is a plot of certain operating parameters of a typical well service pump for valve springs having various strengths, i.e. spring constants. The vertical scale is normalized net positive suction head required, e.g. the pressure at inlet 16 of FIG. 1. The horizontal scale is the percentage of maximum pump speed. The curves indicate the suction head required at the various pump speeds to avoid cavitation and show that the suction head generally must be increased as the pump speed, and therefore fluid flow rate, is increased. Curve 32 is for a relatively stiff or strong valve spring. For a stiff spring, the pump may be operated at 25% of maximum speed with a suction head pressure of only 30% of maximum to avoid cavitation. To operate the pump at 95% of maximum speed with a stiff spring, the suction head pressure must be increased to about 95% of maximum to avoid cavitation.

Curve 34 is for a relatively weak valve spring and represents the weakest spring that can be used without risking damage caused by impact of the valve plug on the spring retainer and without causing flutter. For this weak spring, the pump may be operated at about 25% of its maximum speed with a suction head of only about 8% of maximum. At about 95% of maximum pump speed the suction head pressure is required to be about 62% of maximum without cavitation. Thus, the weak spring allows the valve to open at lower suction head pressures without cavitation.

Curves 32, 34 are each for a valve with a single closing spring, e.g. spring 26 shown in FIG. 1. Curve 36 is for a valve with a two spring system according to the present invention which allows the otherwise identical pump to be operated at lower suction head pressure without cavitation. Curve 36 shows that the pump may be operated at about 25% of maximum speed at a suction head pressure of only about 5% of maximum. The pump may be operated at about 95% of maximum speed at a suction head pressure of only about 30% of maximum while still avoiding cavitation. The system of the present invention therefore provides a substantial reduction in suction head pressure required, especially at high pump speeds which are desirable for high pumping rates of well service fluids, for example in a fracturing operation.

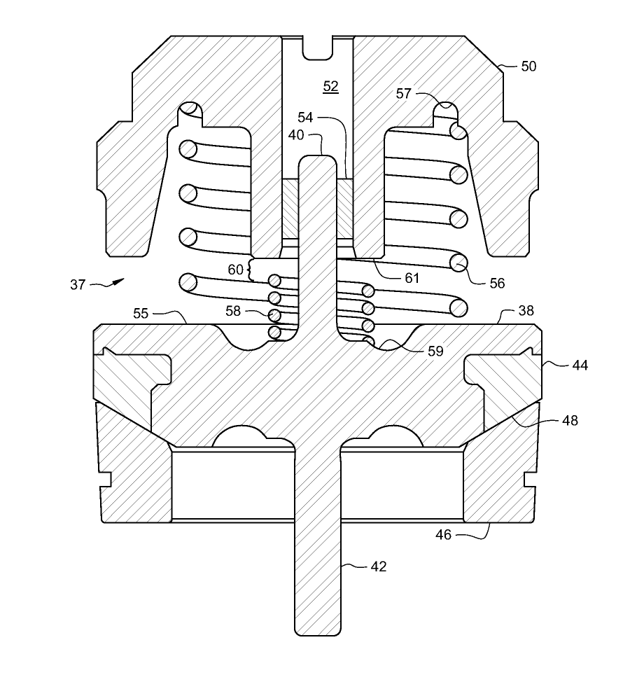

FIG. 3 is a cross section view of an embodiment of an improved pump valve 37, which in an embodiment may be incorporated into a positive displacement pump such as that shown in FIG. 1. The valve 37 includes a valve plug 38 having an upper valve stem 40 and, in this embodiment, a lower valve stem 42. Valve plug 38 and stems 40, 42 may be integral and may be made of a strong wear and corrosion resistant metal such as heat treated steel, or may be made of other material such as stainless steel. In this embodiment, an elastomeric insert 44 is carried on an outer periphery of valve plug 38. A valve seat 46 is illustrated below valve plug 38. The valve seat 46 may also be made of strong wear and corrosion resistant metal such as heat treated steel, or may be made of other material such as stainless steel. An upper surface 48 of seat 46 is shaped to form a fluid seal with lower surfaces of valve plug 38 and insert 44 when the valve plug is in its closed position in contact with the seat 46 as illustrated. A spring retainer 50 is positioned above valve plug 38. The valve stem 40 is slidably carried in a guideway 52 in the retainer 50 which maintains proper alignment of the valve plug 38 with the valve seat 46. The retainer 50 also functions as a valve guide and functions as a valve plug stop, i.e. limits the maximum lift of the valve plug 38. Preferably a bushing 54 of suitable bearing material is provided between the valve stem 40 and the guideway 52. A second guideway and bushing for the lower stem 42 may be provided in, or connected to, the valve seat 46 as shown in FIG. 1. Alternatively, the lower stem 42 may be omitted if desired as also disclosed in the above referenced U.S. Pat. No. 5,226,445.

A first, or main, valve spring 56 is positioned between and acts upon the valve plug 38 and the retainer 50. The first spring 56 may be a coil spring shaped and positioned generally like prior art suction valve springs. The spring 56 is compressed even when the valve plug 38 is in its closed position in contact with the valve seat 48, and thereby provides a selected amount of closing force, or preload, to maintain the valve closed until and unless sufficient differential pressure is provided to open the valve plug 38. However, in this embodiment the first spring 56 may be a much weaker spring than could be used in prior art valves. This weak spring has the advantage that the suction head pressure required to operate a pump without cavitation is reduced as illustrated by curve 36 of FIG. 2. In other words, selecting and employing a first spring 56 having a relatively low spring force, i.e., a weak spring, allows the valve to open quickly upon the suction stroke and helps prevent cavitation. In this embodiment, the first spring 56 is preferably made of a corrosion resistant metal such as stainless steel.

A second, or secondary, valve spring 58 is also provided in valve 37 of FIG. 3. The second spring is positioned between and acts upon the retainer 50 and valve plug 38. In embodiments, the first and second springs may be concentric with one another, e.g., the second spring positioned within the first or vice-versa. In the embodiment shown in FIG. 3, the second spring has a diameter smaller than first spring 56 and is carried on valve stem 40 inside the first spring 56, with the understanding that the relative positions of the springs may be switched in other embodiments. In this embodiment, the second spring 58 is preferably made of a corrosion resistant metal such as stainless steel. The second spring 58 is not compressed when the valve plug 38 is in a closed position in contact with the seat 48 and does not provide a preload force to the valve plug 38 when valve 37 is closed. In an embodiment, the length of second spring 58 is selected to provide an initial gap 60 between the spring 58 and the retainer 50, between the spring 58 and valve plug 38, or a gap between both, depending upon the orientation of valve 37 in the closed position. The initial gap 60 is therefore the distance that the valve plug 38 must open, or lift, before the second spring 58 contacts both the retainer 50 and valve plug 38 and begins to be compressed by further opening of the valve plug 38. When the second spring 58 is used in combination with the weak first spring 56, a pump may be operated under the conditions indicated by curve 36 of FIG. 2 without cavitation or flutter.

In various embodiments, the size of the initial gap may be adjusted via the shape and configuration of the retainer 50, the valve plug 38, or both in addition to or in lieu of using different spring lengths. For example, the first and second springs may be the same length, provided however that they are positioned such that the first spring is providing a preload force between the the retainer 50 and valve plug 38 when the valve is in a closed position, and the second spring does not come into contact and apply a force against the the retainer 50 and valve plug 38 until after the valve begins to open a predetermined distance. For example, a groove could be formed in the retainer 50, valve plug 38, or both to accommodate one or more secondary springs and thereby providing an effective gap as described herein. For example, as shown in FIG. 3, the first and second springs are arranged concentrically and are in contact with and act upon different locations of the retainer 50 and valve plug 38. For example, first spring 56 resides within groove 57 in retainer 50 and contacts the upper surface 55 of valve plug 38 while the second, concentric spring 58 resides within groove 59 in valve plug 38 and contacts an extended shoulder portion 61 of retainer 50. As shown in FIG. 3, the gap 60 could be adjusted by changing the length of spring 58, the length of extended shoulder portion 61, the depth of groove 59, or any combination thereof.

The dual spring system of valve 37 of FIG. 3 functions in several ways to improve valve performance. When the valve 37 is closed, only the first spring 56 provides the initial preload force that must be overcome by pressure differential in order to open the valve 37. Since spring 56 is weaker than springs that could be used in the prior art, the valve 37 opens more quickly and at lower suction inlet pressure to thereby avoid cavitation. If the second spring 58 was not used, the first spring 56 may allow the valve plug 38 to open so quickly that it may make direct contact with the retainer 50 causing an impact on each cycle of the valve 37 and damaging or breaking the valve plug 38 and/or the retainer 50. In addition, the weak spring 56 alone may allow the valve plug 38 to flutter, again possibly causing damage and reducing the flow efficiency of the valve 37. The weak spring 56 alone may not provide a desirable closing force to speed closing of the valve 37 as the discharge stroke begins, which may reduce the volumetric efficiency of the pump.

The second spring 58 does not provide closing force to the valve plug 38 until the valve plug 38 has opened by a distance equal to the preselected initial gap 60. On the suction cycle, the weak first spring 56 allows the valve plug 38 to open quickly and it may be moving at relatively high speed when the initial gap 60 is closed and the second spring 58 makes initial contact with the retainer 50. The second spring 58 is then compressed by the moving valve plug 38 and brings it to a stop without direct impact between the valve plug 38 and retainer 50. Impact forces are therefore avoided. The second spring 58 is then compressed to some extent by the suction force on the valve during the suction stroke. This compression of second spring 58 together with compression of first spring 56 holds the valve plug 38 in a desired open position without flutter during the suction stroke. At the end of the suction stroke, the compression of second spring 58 together with compression of first spring 56 provides force to start movement of the valve plug 38 toward its closed position as desired for the discharge stroke. When the second spring 58 is extended to its unloaded length, the first spring continues to provide closing force to the valve plug 38 to move it into its closed position. As in prior art systems, the preload provided by the closing spring need not be enough to form a fluid tight seal by itself, since the high pressure of the discharge stroke provides more than enough force to effectively close the suction valve 37.

A two spring system of the present disclosure may be described as providing benefits of both a weak spring constant and a strong spring constant. Spring constant is the force required to compress a spring a given distance, for example measured in pounds force per inch of compression. As shown in FIG. 2, a weak spring provides the benefit of allowing high pump speed at low suction head pressure. A strong spring provides advantages of avoiding flutter and mechanical impacts of the valve plug with the guide. The disclosed two spring system provides both benefits. During initial opening of valve plug 38, the total spring constant is only that of the first weak spring 56, which may be less than the spring constant that could be used in prior art valves. Once valve plug 38 opens by a distance equal to the initial gap 60, the effective spring constant is the total of the spring constants of both the first spring 56 and the second spring 58. This total spring constant may be greater than that of the spring corresponding to curve 34 and may be as strong as the spring corresponding to curve 32, while still allowing the pump to be operated safely at relatively low suction head pressure.

In an embodiment, a valve system comprises a plurality of concentric springs of differing lengths and/or differing spring constants positioned between and acting upon the spring retainer 50 and the valve plug 38. The above described embodiments use a plurality or multiple spring system having a two springs. If desired, a plurality or multiple spring system may include three or more springs. Such multiple spring systems may include a main spring, e.g. first spring 56, which has an uncompressed length greater than the distance between the spring retainer 50 and the valve plug 38 when valve 37 is closed. The extra length of the main spring 56 provides a preload force on the valve plug 38. Multiple spring systems may include one or more secondary springs, e.g. two secondary springs 58, which are shorter than the distance between the spring retainer 50 and the valve plug 38 when valve 37 is closed and therefore provide no preload force. If two secondary springs are used, they may be of different lengths, spring constants, and/or diameters, and may have different initial gaps 60. If two secondary springs with different initial gaps are used, the combination of the three springs would provide three different effective spring constants at various valve lift distances.

While the main spring is described as a single spring, it could comprise multiple springs. If two or more main springs are positioned between a spring retainer and a valve plug and are all in contact with both the retainer and the plug when the valve is closed, the multiple springs are the functional equivalent of a single main spring having the combined spring constants. Such a combination alone would not provide different spring constants at different valve plug lift distances as in the disclosed embodiments, but such could be provided via the further combination of a plurality of main springs with one or more secondary springs as disclosed herein.

With further reference to FIG. 2, several examples of spring constants and dimensions are provided to further illustrate the embodiments, but are not intended to limit the scope of the invention. The spring constant for the curve 32 may be one hundred pounds per inch, the spring constant for curve 34 may be fifty pounds per inch and the spring constants for both springs for curve 36 may be twenty-five pounds per inch. The spring constant for curve 36 would therefore be fifty pounds per inch after the second springs begins to be compressed. If desired, the uncompressed lengths of the main springs may be selected to provide the same preload force. If a maximum valve plug lift of two inches is desired, it may be desirable to provide an initial gap about one inch for the second spring after which the total spring constant would be fifty pounds. In another embodiment, it may be desirable in a two spring system for the first spring to have a spring constant of twenty-five pounds per inch and the second spring to have a spring constant of fifty pounds per inch, which would provide the same total force at two inches of valve lift as a single fifty pound per inch main spring. Potential spring constants for a two spring system according to the disclosed embodiments may be from ten to twenty-five pounds per inch for the primary spring and twenty to fifty pounds per inch for the secondary spring.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Accordingly, the scope of protection is not limited by the description set out above, but is defined by the claims which follow, that scope including all equivalents of the subject matter of the claims. Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings refer to a “Field of the Invention,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. The term “comprising” as used herein is to be construed broadly to mean including but not limited to, and in accordance with its typical usage in the patent context, is indicative of inclusion rather than limitation (such that other elements may also be present). In all instances, the scope of the claims shall be considered on their own merits in light of this disclosure, but should not be constrained by the headings set forth herein.

What we claim as our invention is:

1. A valve, comprising:
a valve seat,
a valve plug adapted to contact the valve seat,
a spring retainer spaced from the valve plug, and
a plurality of springs positioned between the spring retainer and the valve plug.

2. The valve of claim 1, wherein at least one of the multiple springs is compressed when the valve plug is in contact with the valve seat and at least one of the multiple springs is not compressed when the valve plug is in contact with the valve seat.

3. The valve of claim 1, wherein the plurality of springs comprises:
a first spring positioned between the spring retainer and the valve plug, the first spring having an uncompressed length greater than the distance between its contact points with the spring retainer and the valve plug when the valve plug contacts the valve seat, and
a second spring positioned between the spring retainer and the valve plug, the second spring having an uncompressed length less than the distance between its contact points the spring retainer and the valve plug when the valve plug contacts the valve seat.

4. The valve of claim 3 wherein the first spring is longer than the second spring.

5. The method of claim 3 wherein the first spring and the second spring are concentric.

6. The method of claim 4 wherein the first spring and the second spring are concentric.

7. The valve of claim 1, further comprising:
a guideway within the spring retainer, and
a valve stem coupled to the valve plug, the valve stem slidably carried within the guideway.

8. The valve of claim 3, further comprising:
a guideway within the spring retainer, and
a valve stem coupled to the valve plug, the valve stem slidably carried within the guideway,
wherein the first spring is longer than the second spring and the first spring and the second spring are concentric.

9. The valve of claim 1, further comprising an elastomeric insert carried on an outer periphery of the valve plug and positioned to contact the valve seat when the valve plug contacts the valve seat.

10. An oilfield service pump, comprising:
a cylinder,
a piston carried in the cylinder,
a suction inlet,
a suction valve coupled between the cylinder and the suction inlet, the suction valve comprising a multiple spring valve actuator.

11. The oilfield service pump of claim 10, wherein at least one of the multiple springs is compressed when the valve is closed and at least one of the multiple springs is not compressed when the valve is closed.

12. The oilfield service pump of claim 10, wherein the multiple spring valve actuator comprises:
a first spring having an uncompressed length selected so that the first spring is compressed when the suction valve is closed; and
a second spring having an uncompressed length selected so that the second spring is not compressed when the suction valve is closed.

13. The oilfield service pump of claim 12, wherein:
the second spring uncompressed length is selected so that the second spring is not compressed unless the valve opens by at least a preselected lift distance.

14. A method for operating a positive displacement pump comprising:
providing a positive displacement pump having a suction valve and an actuator biasing the suction valve toward a closed position, and
equipping the actuator with a plurality of springs.

15. The method of claim 14, wherein the plurality of springs comprises a first spring and a second spring, and wherein the equipping further comprises:
selecting the first spring to have an uncompressed length greater than a distance between a spring retainer and a valve plug when the valve is closed, and,
selecting the second spring to have an uncompressed length less than a distance between the spring retainer and the valve plug when the valve is closed.

16. A method of operating a positive displacement pump, comprising:
applying a first spring force to a spring retainer and a valve plug of the pump prior to or concurrent with beginning a suction stroke of the pump; and
applying a second, cumulative spring force to the spring retainer and the valve plug prior to completion of the suction stroke.

17. The method of claim 16 wherein the first and second spring forces are provided by a plurality of springs.

18. The method of claim 17, wherein the plurality of springs comprises a first spring and a second spring, and wherein the method further comprises selecting a length of the first or second spring, selecting a spring force of the first or second spring, selecting a distance between the spring retainer and the valve plug corresponding to contact points with the first or second spring, or combinations thereof to apply the first and second spring forces.

19. A method of servicing a wellbore comprising:
opening a pump valve and drawing a wellbore servicing fluid into the pump via a suction stroke of the pump, wherein a first spring force biases the valve closed prior to the suction stroke and wherein a second, cumulative spring force is applied to the valve during the suction stroke, and
closing the pump valve and discharging a wellbore servicing fluid from the pump and into the wellbore.

20. The method of claim 19 wherein the wellbore servicing fluid comprises a drilling fluid, a cementitious fluid, or a fracturing fluid.
